(19) United States
(12) Patent Application Publication
(10) Pub. No.: US 2026/0099472 A1
(43) Pub. Date: Apr. 9, 2026

(54) AUTOMATED EXTENSION OF DATABASE FIELD LENGTH

(71) Applicant: Wells Fargo Bank, N.A., San Francisco, CA (US)

(72) Inventors: Mamta Vijaykumar Annigeri, Hyderabad (IN); Ramya Balasubramanian, Hyderabad (IN); Santhosh Biradar, Telangana (IN); Balakrishna Katamarthini, Hyderabad (IN); Rameshchandra Bhaskar Ketharaju, Hyderabad (IN); Durai Amuthan Natarajan, Hosur (IN)

(21) Appl. No.: 18/909,577

(22) Filed: Oct. 8, 2024

(51) Int. Cl. G06F 16/21

(52) U.S. Cl. CPC G06F 16/213

(57) ABSTRACT

An example computer system for automating an extension of field length in a database can include: one or more processors; and non-transitory computer-readable storage media encoding instructions which, when executed by the one or more processors, causes the computer system to: automatically determine when data in a first column of a table in the database exceeds a field length; define a chunk size for the data in the first column; create a second column in the table; break the data into a first portion to be stored in the first column and a second portion to be stored in the second column; and create a vector representing the data stored in the first column and the second column.

### BACKGROUND

In conventional database management systems, administrators typically must specify fixed column lengths based on expected data sizes. However, this rigid approach often results in data truncation when input exceeds the defined column length, leading to loss of valuable information and potential database inconsistencies. Existing solutions involve manual intervention to modify column lengths, which is time-consuming and prone to errors.

### SUMMARY

Examples provided herein are directed to the automated extension of data field lengths.

According to one aspect, an example computer system for automating an extension of field length in a database can include: one or more processors; and non-transitory computer-readable storage media encoding instructions which, when executed by the one or more processors, causes the computer system to: automatically determine when data in a first column of a table in the database exceeds a field length; define a chunk size for the data in the first column; create a second column in the table; break the data into a first portion to be stored in the first column and a second portion to be stored in the second column; and create a vector representing the data stored in the first column and the second column.

According to another aspect, an example method for automating an extension of field length in a database can include: automatically determining when data in a first column of a table in the database exceeds a field length; defining a chunk size for the data in the first column; creating a second column in the table; breaking the data into a first portion to be stored in the first column and a second portion to be stored in the second column; and creating a vector representing the data stored in the first column and the second column.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for the automated extension of data field lengths.

FIG. 2 shows example logical components of a server device of the system of FIG. 1.

FIG. 3 shows an example communication flow between components of the system of FIG. 1.

FIG. 4 shows example physical components of the server device of FIG. 2.

### DETAILED DESCRIPTION

This disclosure relates to the automated extension of data field lengths.

More specifically, embodiments described herein provide for the automatic extension of database columns by creating new columns when input data exceeds a defined column length. The approach minimizes the need for manual intervention by dynamically generating new columns to accommodate overlength data fields, thereby enhancing data integrity and minimizing data loss.

The concept can include one or more of the following:
a combination of defined (or fixed-length) character fields and variable-length character (VARCHAR) fields and vector representations, which optimizes data storage, retrieval, and compression;
adaption of chunk sizes based on data characteristics, ensuring efficient handling of variable-length character data; and
leveraging of Artificial Intelligence (AI) techniques for query processing and optimization enhances performance and scalability.

In the examples provided herein, algorithms are used to dynamically determine whether input exceeds the defined column length and trigger column extension procedures accordingly. Vector database methods can be used to transform data into vector representations, enabling efficient indexing, similarity searching, and retrieval. This can also support data chunking for generative AI solutions.

To handle dynamic data growth or changes, the concept dynamically adjusts chunk sizes and vector representations, enabling scalability and adaptability to varying data volumes. During query execution, the query processor interprets user queries and utilizes vector representations for efficient search and retrieval. Relevant data chunks are retrieved based on query criteria.

There can be various advantages associated with the technologies described herein. For instance, this concept bridges the gap between variable-length and fixed-length character fields, providing an efficient and flexible solution for managing character on demand data in database systems. Further, the algorithms provided herein can be used to dynamically determine when an input exceeds a fixed column length and automatically changes chunk sizes and vector representations, thereby increasing the efficiency and integrity of the stored data.

Other advantages can include the seamless data handling, which minimizes data truncation issues by dynamically adjusting column lengths, ensuring complete data storage and retrieval. Further, the examples provided herein can improved data integrity by minimizing the risk of data loss and inconsistencies by accommodating varying input lengths without manual intervention. The examples can provide a hassle-free data management experience, reducing the need for manual column adjustments.

Further, these examples can be scalable, adapting to diverse database environments and scalable to handle increasing data volumes and complexities. This can result in reductions in the number of incidents and emergency/normal changes to fix the length of data fields. Many other advantages are possible.

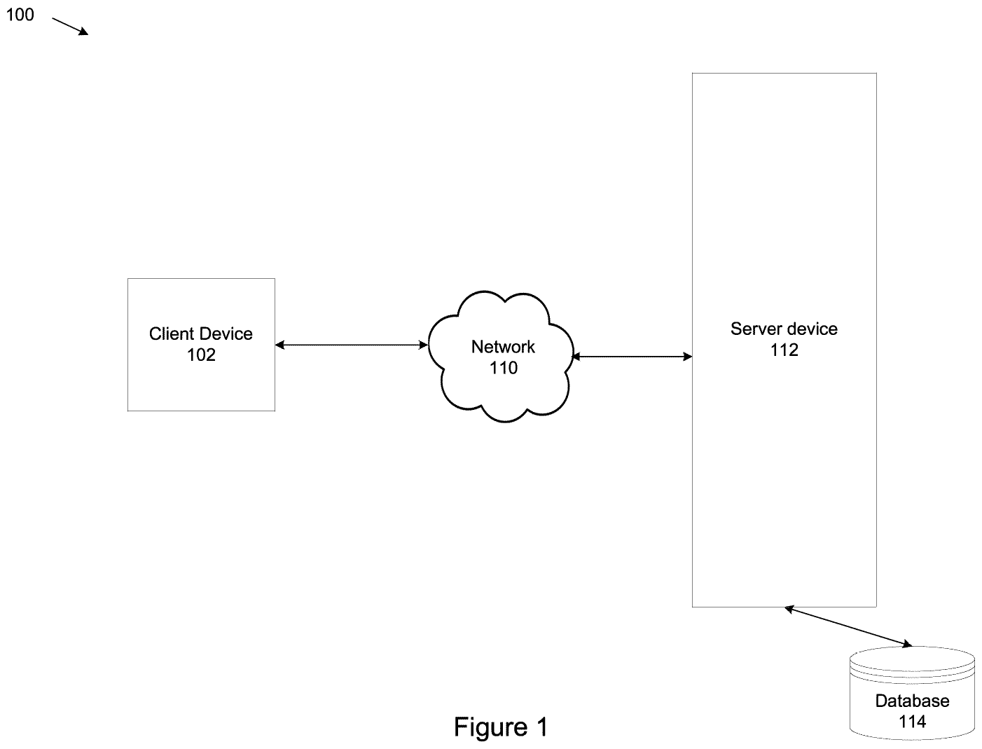

FIG. 1 schematically shows aspects of one example system 100 programmed to automate the extension of data field lengths. In this example, the system 100 can be a computing environment that includes a plurality of client and server devices. In this instance, the system 100 includes a client device 102, a server device 112, and a database 114. The client device 102 can communicate with the server device 112 through a network 110 to accomplish the functionality described herein.

Each of the devices may be implemented as one or more computing devices with at least one processor and memory. Example computing devices include a mobile computer, a desktop computer, a server computer, or other computing device or devices such as a server farm or cloud computing used to generate or receive data.

In some non-limiting examples, the server device 112 is owned by a financial institution, such as a bank. The client device 102 can be programmed to communicate with the server device 112 to access information stored in the database 114. Many other configurations are possible.

For instance, the example client device 102 is programmed to access the server device 112 through the network 110 to store or retrieve data. In one example, the client device 102 can be customer device that accesses the server device 112 to perform financial transactions. In other examples, the client device 102 can be another device associated with the system 100, such as an automated teller machine that accesses the server device 112 for various business purposes, such as to complete withdrawal and deposit requests.

The example server device 112 is programmed to perform various business-related tasks for the system 100. For example, as noted above, the server device 112 can perform financial transactions when queried by the client device 102. The server device 112 can access the database 114 to perform the financial transactions. For example, the server device 112 can use queries, such as add, update, or delete, to retrieve and store data in the database 114. The server device 112 can also utilize the functionality provided herein to accommodate data of varying length, as provided further below.

The example database 114 is programmed to store and retrieve data for the server device 112. In examples provided herein, the database 114 can be of various types, such as a relational database, an object-oriented database, and a hierarchical database. In this example, the database 114 stores data in one or more tables, with each table having columns of data of varying length. As provided below, the size of each column can be manipulated to accommodate the data of varying length.

The network 110 provides a wired and/or wireless connection between the client device 102 and the server device 112. In some examples, the network 110 can be a local area network, a wide area network, the Internet, or a mixture thereof. Many different communication protocols can be used. Although only a few devices are shown, the system 100 can accommodate hundreds, thousands, or more of computing devices.

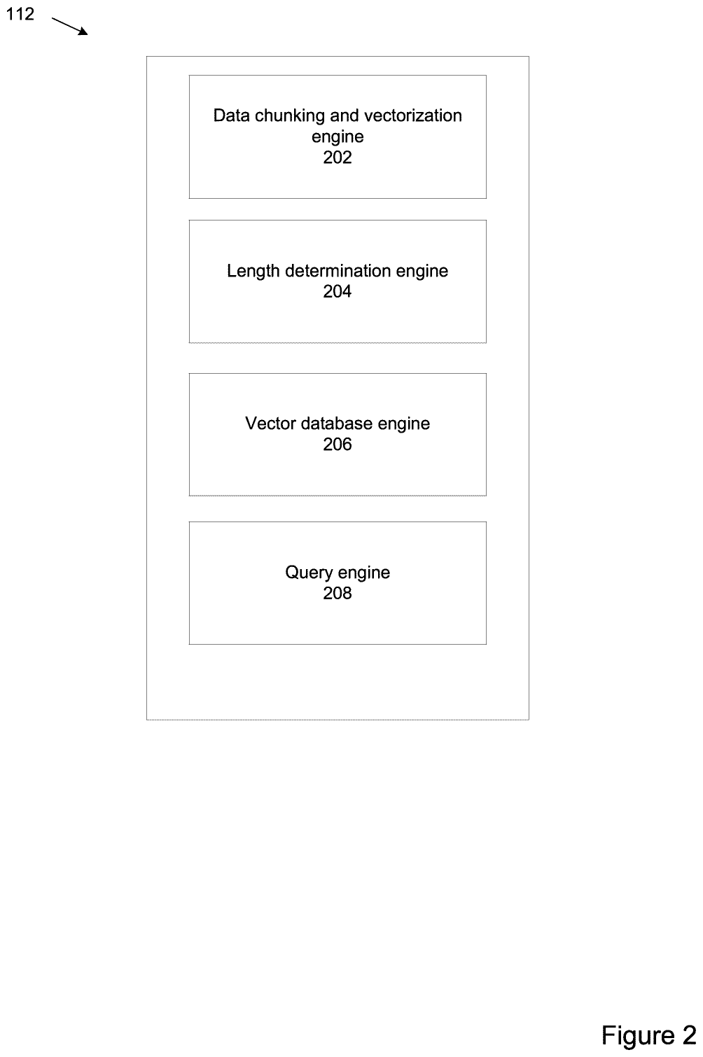

Referring now to FIG. 2, additional details of the server device 112 are shown. In this example, the server device 112 has various logical engines that assist in the automated extension of data fields. The server device 112 includes, in this instance, a data chunking and vectorization engine 202, a database management engine 204, a vector database engine 206, and a query engine 208. In other examples, more or fewer engines providing different functionality can be used.

Generally, these components of the server device 112 are programmed to determine the proper field length for tables stored in the database 114. This field length can change over time or as data needs evolve. For instance, certain fields can be open in length, such as the length of a name (as provided in the example below). The server device 112 is configured to accommodate these different field lengths so that data is not lost, thereby meeting regulatory obligations.

More specifically, the components of the server device 112 enhance data management in the database 114, specifically addressing the trade-offs between variable-length VARCHAR and fixed-length VARCHAR. By leveraging emerging technologies and AI-driven approaches, the system 100 optimizes data storage, retrieval, compression, and/or query performance.

The data chunking and vectorization engine 202 is programmed to manage data chunks and vector representations. The data chunking and vectorization engine 202 utilizes AI techniques to optimize data storage and retrieval and integrates with the vector database engine 206.

More specifically, the AI-driven data chunking and vectorization engine 202 chunks large character data into manageable segments. The data chunking and vectorization engine 202 can convert each chunk into vector representations using vector database methods. The data chunking and vectorization engine 202 stores the vectors alongside the defined-length VARCHAR (VARCHAR+).

As data grows or changes, the data chunking and vectorization engine 202 dynamically adjusts chunk sizes and vector representations. This enables scalability and adaptability to varying data volumes.

In one example, the data chunking and vectorization engine 202 is programmed to use data mining techniques to determine what sort of data chunking is necessary, such as which columns will need to be addressed. This can include a training algorithm for the AI, which reads certain columns stored in the tables of the database 114. The data chunking and vectorization engine 202 learns and thereupon identifies which columns will need to be chunked based upon AI techniques, including an understanding of the data fields and how best to accomplish the chunking to enhance storage and retrieval performance. This can result in more efficient processing and use of memory in the database 114.

An example of chunking as performed by the server device 112 follows. When input is greater than a defined length for a column in a table of the database 114, the database management engine 204 identifies the discrepancy. The data chunking and vectorization engine 202 can thereupon create new column with a suffix as “(+)” and add “(+)” to data at the suffix in the original column to indicate that the new column (VARCHAR+) is created as the input is greater than defined length. Pseudo code for this example follows.

```
CREATE
  TABLE TABL_EMPL-DETAILS
  (
    EMPL_ID NUMBER NOT NULL CONTRAINT EMPL_ID_PK
  PRIMARY KEY
    ,
    FIRST_NAME VARCHAR2(10)
    ,
    LAST_NAME VARCHAR2(10) FLEXCHAR
    ,
    CREATE_TS TIMESTAMP(6) DEFAULT SYSTIMESTAMP
  )
```

In Table 1 below, the LAST_NAME column is limited to 11 characters. For the sole entry, this is not an issue, since the last name of “ROGER” is shorter than the maximum length of the column LAST_NAME.

| EMPL_ID | FIRST_NAME | LAST_NAME | CREATE_TS |
|---|---|---|---|
| 100 | SAM | ROGER | May 17, 2024 7:44:44 AM |

However, in Table 2 below, the second entry includes a last name of ROGER PHINNAUES, which is longer than the maximum length for the LAST_NAME field. In this example, the database management engine 204 determines that the maximum length for the LAST_NAME column has been exceeded, and the data chunking and vectorization engine 202 creates a new VARCHAR+column labeled “LAST_NAME (+)” to indicate the column is an extension of the “LAST_NAME” column.

| EMPL_ID | FIRST_NAME | LAST_NAME | LAST_NAME(+) | CREATE_TS |
|---|---|---|---|---|
| 100 | SAM | ROGER | (null) | May 17, 2024 7:44:44 AM |
| 101 | SAM | ROGER P(+) | HINNAEUS | May 17, 2024 7:45:11 AM |

When storing the data for the second entry, the vector database engine 206 is programmed to store a first portion of the last name (“ROGER P”) in the LAST_NAME column and the remaining portion (“HINNAEUS”) in the LAST_NAME(+) column. The suffix “(+)” designations indicate the extension, so that the data can be reassembled by the query engine 208 upon retrieval.

The database management engine 204 is programmed to determine, based on real-time input data analysis, whether the input data field for a given column exceeds the defined column length within a table stored in the database 114. Upon such a determination, the database management engine 204 can trigger column extension procedures, as described herein. This accommodates extra characters beyond the fixed length.

For instance, the database management engine 204 can be programmed to understand column restraints, such as the length of data accommodated in a column. When a column has a maximum field length of 10 characters and the table includes data fields of a greater length (e.g., 12 characters), the excess characters can be stored in a new column created in the database 114, as provided below.

The vector database engine 206 is programmed to facilitate the storage and retrieval of vectorized data from the database 114. This can include the vector database engine 206 transforming data into vector representations, enabling efficient indexing, similarity searching, and retrieval. The vector database engine 206 also supports chunking of data by the data chunking and vectorization engine 202.

For instance, the vector database engine 206 can be programmed to divide a document into smaller sections (chunks) based on paragraphs, sentences, or logical subsections. The vector database engine 206 then transforms each chunk of text into a vector representation, and each chunk (along with its vector) is stored as a separate entry in the database 114.

When the database 114 is queried, the query can also be converted into a vector. The vector database engine 206 (along with the query engine 208 described below) compares the query vector with the stored vectors and retrieves chunks that are most similar.

The query engine 208 is programmed to interpret user queries and optimize execution plans and utilizes vector representation for efficient query processing. This also allows for seamless integration with existing Structured Query Language-based systems.

More specifically, when the client device 102 sends a query to the server device 112, the query engine 208 interprets the query. The query engine 208 thereupon uses vector representations for efficient search and retrieval of the requested data from the database 114. In some instances, the query engine 208 retrieves relevant data chunks based on the query criteria.

For instance, the query engine 208 can convert the query into a vector representation using the same vectorization model that was used for storing the chunks. The vector database engine 206 compares the query vector to the vectors of all the stored chunks in the database 114 using a similarity metric and retrieve most relevant chunks and results are returned.

Consider a long document (like an article or a book chapter) that needs to be stored in a vector database for efficient searching and retrieval, titled “History of Space Exploration,” that spans multiple pages. The document contains sections on different eras of space exploration, key missions, and notable astronauts. An example of vectorization as provided by the vector database engine 206 and the query engine 208 follows.

1. Chunking the Data: The document is divided into smaller sections (chunks) based on paragraphs, sentences, or logical subsections. For instance, the document might be chunked like this:
Chunk 1: “The early years of space exploration began in the 1950s . . . ”
Chunk 2: “NASA's Apollo missions were a landmark achievement in human . . . ”
Chunk 3: “In 2021, SpaceX successfully sent astronauts to the International Space . . . ”
Chunk 4: “Future missions aim to explore Mars and beyond . . . ”

2. Vectorizing Each Chunk: Each chunk of text is transformed into a vector representation using techniques like word embeddings or sentence embeddings (e.g., using a pre-trained language model like BERT). For example:
Chunk 1 vector: [0.12, 0.34, 0.56, 0.78, . . . ]
Chunk 2 vector: [0.11, 0.32, 0.51, 0.71, . . . ]
Chunk 3 vector: [0.21, 0.31, 0.44, 0.69, . . . ]
Chunk 4 vector: [0.14, 0.38, 0.52, 0.80, . . . ]

3. Storing in the Database: Each chunk (along with its vector) is stored as a separate entry in the vector database. The structure might look like this:

| Chunk ID | Content (text) | Vector (representation) |
|---|---|---|
| 001 | “The early years of space exploration . . . ” | [0.12, 0.34, 0.56, 0.78, . . . ] |
| 002 | “NASA's Apollo missions were a landmark . . . ” | [0.11, 0.32, 0.51, 0.71, . . . ] |
| 003 | “In 2021, SpaceX successfully sent astronaut . . . ” | [0.21, 0.31, 0.44, 0.69, . . . ] |
| 004 | “Future missions aim to explore Mars . . . ” | [0.14, 0.38, 0.52, 0.80, . . . ] |

4. Retrieving Data from the Database: When a user queries the database (e.g., searching for information about Apollo missions), the query is also converted into a vector. The vector database compares the query vector with the stored vectors and retrieves chunks that are most similar (e.g., Chunk 2 on Apollo missions).

Assume multiple documents about famous space missions have been stored in the database 114. The documents have been chunked and each chunk has been vectorized before being stored in the database.

### Scenario: Querying a Vector Database for Apollo Missions

You have a vector database with data chunked and stored from various documents. Here are a few chunks of data in the database:
Chunk 1: In 1961, Yuri Gagarin became the first human to travel into space, marking the start of the space race.
   Vector: [0.15, 0.32, 0.45, 0.78, . . . ]
Chunk 2: NASA's Apollo 11 mission in 1969 successfully landed humans on the Moon for the first time.
   Vector: [0.22, 0.34, 0.56, 0.79, . . . ]
Chunk 3: The Apollo 13 mission encountered critical system failures but managed to return the crew safely to Earth.
   Vector: [0.23, 0.36, 0.57, 0.81, . . . ]
Chunk 4: SpaceX's Starship aims to make space travel more affordable and sustainable in the future.
   Vector: [0.12, 0.25, 0.33, 0.68, . . . ]

### Step-by-Step Data Retrieval Example:

Step 1: User Query: A user queries the database with the text: “Information about the Apollo moon landing.”
Step 2: Vectorization of the Query: The query is converted into a vector representation using the same vectorization model that was used for storing the chunks. Assume the query vector is: [0.20, 0.35, 0.55, 0.80, . . . ].
Step 3: Search for Similar Vectors: The vector database compares the query vector to the vectors of all the stored chunks in the database using a similarity metric. An example comparison follows.
Query vector vs Chunk 1 vector: Low similarity score (no match).
Query vector vs Chunk 2 vector: High similarity score (strong match).
Query vector vs Chunk 3 vector: Medium similarity score (partial match).
Query vector vs Chunk 4 vector: Low similarity score (no match).
Step 4: Retrieve Most Relevant Chunks: Based on the similarity scores, the vector database retrieves the most relevant chunks. In this case, Chunk 2 (about Apollo 11) and Chunk 3 (about Apollo 13) are the closest matches.
Result 1 (Chunk 2): NASA's Apollo 11 mission in 1969 successfully landed humans on the Moon for the first time.
Result 2 (Chunk 3): The Apollo 13 mission encountered critical system failures but managed to return the crew safely to Earth.
Step 5: Return the Results to the User: The system then returns these two chunks to the user, along with links to the full documents, if necessary.

This example demonstrates how the vector database efficiently retrieves the most relevant information by comparing vector representations, even though the database stored large, complex documents in smaller, manageable chunks. Many other examples and configurations are possible.

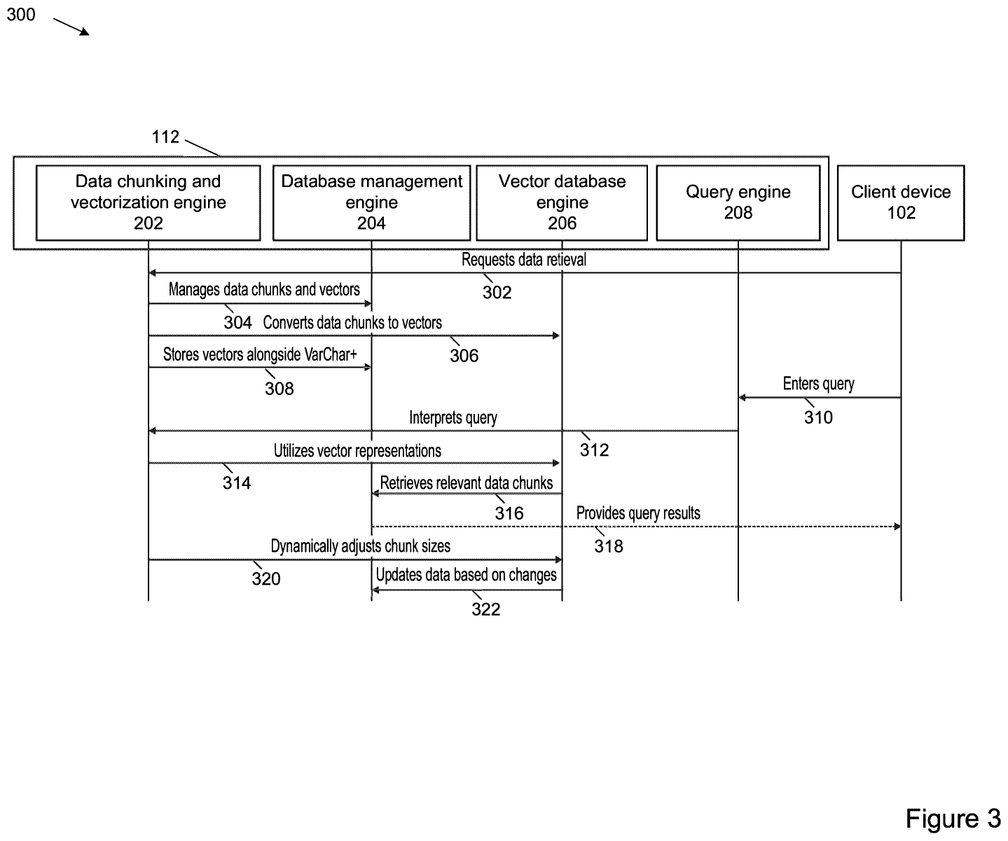

FIG. 3 illustrates an example diagram 300 of the sequence of communications between the client device 102 and the server device 112 during a request for data (operations 302, 304, 306, 308) and a query for data (operations 310, 312, 314, 316, 318) in the database 114.

At operation 302, the client device 102 requests data retrieval from the database 114 through the server device 112. Next, at operation 304, the data chunks and vectors associated with the request are managed. The data chunks are then converted to vectors at operation 306. Finally, at operation 308, the database 114 stores the vectors alongside the defined-length VARCHAR (VARCHAR+).

At operation 310, a query for data is received from the client device 102, which is interpreted by the query engine 208. The query is interpreted at operation 312, and AI can utilize vector representations for efficient search and retrieval. Next, at operations 314 and 316, the database 114 retrieves relevant data chunks based on the query criteria. The results are returned to the client device 102 at operation 318.

In addition, the diagram 300 illustrates that the system 100 dynamically adjusts chunk sizes as data grows or changes. For instance, at operation 320, the data chunking and vectorization engine 202 automatically adjusts the size of the chunks of data to optimize performance of the database 114. At operation 322, the data is updated based upon the changes in the chunk size. The approach, which combines defined-length character (VARCHAR) fields and variable length character (VARCHAR+) fields and vector representations, can optimize data storage and retrieval while accommodating variable-length character data.

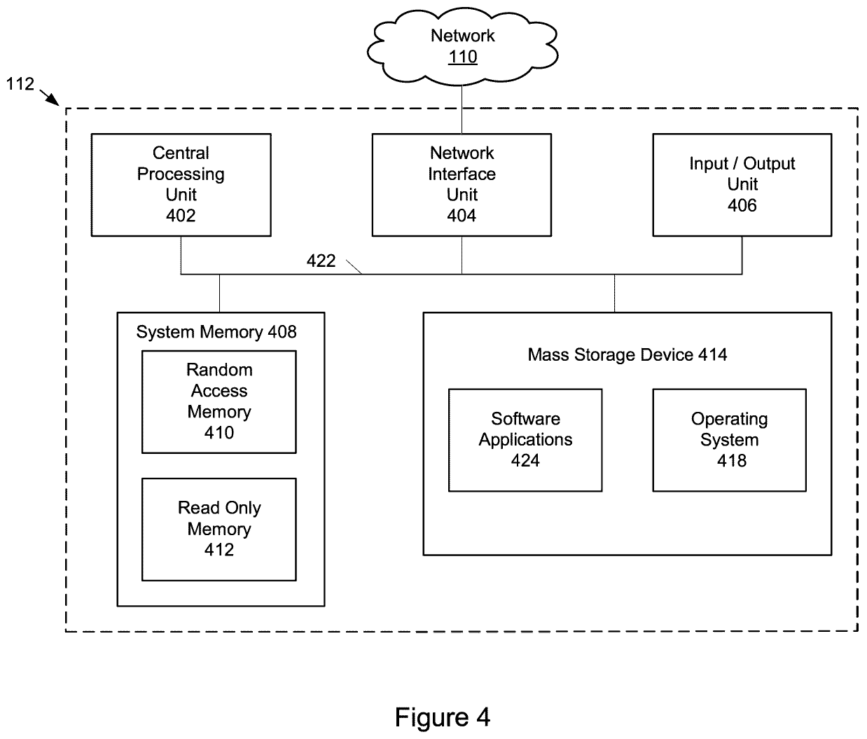

As illustrated in the embodiment of FIG. 4, the example server device 112, which provides at least some of the functionality described herein, can include at least one central processing unit (“CPU”) 402, a system memory 408, and a system bus 422 that couples the system memory 408 to the CPU 402. The system memory 408 includes a random access memory (“RAM”) 410 and a read-only memory (“ROM”) 412. A basic input/output system containing the basic routines that help transfer information between elements within the server device 112, such as during startup, is stored in the ROM 412. The server device 112 further includes a mass storage device 414. The mass storage device 414 can store software instructions and data. A central processing unit, system memory, and mass storage device similar to that shown can also be included in the other computing devices disclosed herein.

The mass storage device 414 is connected to the CPU 402 through a mass storage controller (not shown) connected to the system bus 422. The mass storage device 414 and its associated computer-readable data storage media provide non-volatile, non-transitory storage for the server device 112. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server device 112.

According to various embodiments of the invention, the server device 112 may operate in a networked environment using logical connections to remote network devices through network 110, such as a wireless network, the Internet, or another type of network. The server device 112 may connect to network 110 through a network interface unit 404 connected to the system bus 422. It should be appreciated that the network interface unit 404 may also be utilized to connect to other types of networks and remote computing systems. The server device 112 also includes an input/output controller 406 for receiving and processing input from a number of other devices, including a touch user interface display screen or another type of input device. Similarly, the input/output controller 406 may provide output to a touch user interface display screen or other output devices.

As mentioned briefly above, the mass storage device 414 and the RAM 410 of the server device 112 can store software instructions and data. The software instructions include an operating system 418 suitable for controlling the operation of the server device 112. The mass storage device 414 and/or the RAM 410 also store software instructions and applications 424, that when executed by the CPU 402, cause the server device 112 to provide the functionality of the server device 112 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

1. A computer system for automating an extension of field length in a database, comprising:
one or more processors; and
non-transitory computer-readable storage media encoding instructions which, when executed by the one or more processors, causes the computer system to:
perform data mining on the database by analyzing database structures;
identify patterns in column usage, data types, and storage requirements across the database;
train an artificial intelligence algorithm based upon the data mining and the patterns to develop predictive models for optimal chunking strategies based on database-specific characteristics;
allow the artificial intelligence algorithm to automatically determine when data in a first column of a table in the database exceeds a field length based upon the predictive models;
define, by the artificial intelligence algorithm, a chunk size for the data in the first column, wherein the chunk size is a predetermined size used to divide the data that exceeds the field length into manageable portions for storage across multiple columns to enhance database efficiency;
create a second column in the table;
break the data according to the chunk size into a first portion to be stored in the first column and a second portion to be stored in the second column; and
create a vector representing the data stored in the first column and the second column by transforming the data into a vector representation that enables efficient indexing.

2. The computer system of claim 1, comprising further instructions which, when executed by the one or more processors, causes the computer system to dynamically determine the chunk size based upon characteristics of the data.

3. The computer system of claim 2, wherein the chunk size is adjusted based upon varying data volumes in the database.

4-5. (canceled)

6. The computer system of claim 1, comprising further instructions which, when executed by the one or more processors, causes the computer system to:
receive a query for the data in the database; and
use the vector representing the data stored in the first column and the second column to respond to the query.

7. The computer system of claim 1, comprising further instructions which, when executed by the one or more processors, causes the computer system to:
compare the data to a defined column length; and
determine a length of the data exceeds the defined column length.

8. The computer system of claim 1, comprising further instructions which, when executed by the one or more processors, causes the computer system to create the second column with a designation to identify the second column.

9. The computer system of claim 8, wherein the designation is a special suffix.

10. The computer system of claim 1, comprising further instructions which, when executed by the one or more processors, causes the computer system to add a special suffix to the second portion of the data in the second column.

11. A method for automating an extension of field length in a database, comprising:
performing data mining on the database by analyzing database structures;
identifying patterns in column usage, data types, and storage requirements across the database;
training an artificial intelligence algorithm based upon the data mining and the patterns to develop predictive models for optimal chunking strategies based on database-specific characteristics;
allowing the artificial intelligence algorithm to automatically determine when data in a first column of a table in the database exceeds a field length based upon the predictive models;
defining, by the artificial intelligence algorithm, a chunk size for the data in the first column, wherein the chunk size is a predetermined size used to divide the data that exceeds the field length into manageable portions for storage across multiple columns to enhance database efficiency;
creating a second column in the table;
breaking the data according to the chunk size into a first portion to be stored in the first column and a second portion to be stored in the second column; and
creating a vector representing the data stored in the first column and the second column by transforming the data into a vector representation that enables efficient indexing.

12. The method of claim 11, further comprising dynamically determining the chunk size based upon characteristics of the data.

13. The method of claim 12, wherein the chunk size is adjusted based upon varying data volumes in the database.

14-15. (canceled)

16. The method of claim 11, further comprising:
receiving a query for the data in the database; and
using the vector representing the data stored in the first column and the second column to respond to the query.

17. The method of claim 11, further comprising:
comparing the data to a defined column length; and
determining a length of the data exceeds the defined column length.

18. The method of claim 11, further comprising creating the second column with a designation to identify the second column.

19. The method of claim 18, wherein the designation is a special suffix.

20. The method of claim 11, further comprising adding a special suffix to the second portion of the data in the second column.
